(19) United States
(12) Patent Application Publication
(10) Pub. No.: US 2016/0269247 A1
(43) Pub. Date: Sep. 15, 2016

(54) ACCELERATING STREAM PROCESSING BY DYNAMIC NETWORK AWARE TOPOLOGY RE-OPTIMIZATION

(71) Applicant: NEC Laboratories America, Inc., Princeton, NJ (US)

(72) Inventors: Srimat Chakradhar, Manalapan, NJ (US); Naresh Rapolu, Lafayette, IN (US)

(21) Appl. No.: 15/069,621

(22) Filed: Mar. 14, 2016

Related U.S. Application Data
(60) Provisional application No. 62/132,686, filed on Mar. 13, 2015.

(51) Int. Cl. H04L 12/24; H04L 29/08

(52) U.S. Cl. CPC H04L 41/12; H04L 67/12

(57) ABSTRACT

Aspects of the present disclosure are directed to techniques that improve performance of streaming systems. Accordingly we disclose efficient techniques for dynamic topology re-optimization, through the use of a feedback-driven control loop that substantially solve a number of these performance-impacting problems affecting such streaming systems. More particularly, we disclose a novel technique for network-aware tuple routing using consistent hashing that improves stream flow throughput in the presence of large, run-time overhead. We also disclose methods for dynamic optimization of overlay topologies for group communication operations. To enable fast topology re-optimization with least system disruption, we present a lightweight, fault-tolerant protocol. All of the disclosed techniques were implemented in a real system and comprehensively validated on three real applications. We have demonstrated significant improvement in performance (20% to 200%), while overcoming various compute and network bottlenecks. We have shown that our performance improvements are robust to dynamic changes, as well as complex congestion patterns. Given the importance of stream processing systems and the ubiquity of dynamic network state in cloud environments, our results represent a significant and practical solution to these problems and deficiencies.

### CROSS REFERENCE TO RELATED APPLICATIONS

This application claims the benefit of U.S. Provisional Patent Application Ser. No. 62/132,686 filed Mar. 13, 2015 the entire contents of which are incorporated by reference as if set forth at length herein.

### TECHNICAL FIELD

This disclosure relates generally to networked computing environments and in particular to methods for accelerating stream processing via dynamic network-aware topology re-optimization.

### BACKGROUND

Stream processing engines (SE) are widely used to process continuous streams of data originating from—for example—distributed sensors, user-activity logs, and database transactions. Applications dependent upon such stream processing engines include real-time online analytics—a class of application almost ubiquitous in its use for sensor data processing and deriving valuable information from social network activities. Other use cases and applications for stream processing engines include online machine learning, continuous computation, distributed remote procedure calls (RPC), distributed extract, transfer and load (ETL), among others.

To achieve the high-throughput necessary for such applications, contemporary stream processing engines employ pipelined execution, low-overhead fault-tolerance and efficient group communication overlays. Notwithstanding these methodologies, the throughput of 0 made possible by stream processing engine applications is significantly impacted by a dynamic system state. More particularly, a single bottleneck in a pipeline (e.g., a congested network link or an overloaded operator) can cripple system throughput.

Given the importance of stream processing engines to online activities that have become ubiquitous in contemporary society, techniques that eliminate bottlenecks or accelerate processing performed by stream processing engines would represent a welcome addition to the art.

### SUMMARY

The above bottleneck problems are solved and the accelerated processing of stream processing engines are improved according to an aspects of the present disclosure directed a number of techniques for addressing bottlenecks in stream engines.

In sharp contrast to “expensive” prior art techniques that involve multiple, time-consuming steps including: 1) stopping streams, 2) spawning new operators, 3) copying any necessary states from old operator(s), 4) refreshing network connections, and 5) re-starting streams—techniques according to the present disclosure are shown to achieve significant performance improvements over the prior-art namely, 20% to 200% depending on the particular bottleneck.

Additionally, techniques according to the present disclosure namely, a per-topology controller, which employs novel methods and protocols according to the present disclosure for dynamic, network-aware routing and on-the-fly topology modifications provide such significant performance improvements while being advantageously robust to highly dynamic network state, as well as complex congestion patterns.

Techniques according to the present disclosure include at least three novel techniques to achieve network-aware routing: (i) representing topology link structure using route-maps; (ii) consistent hashing for fine-grained key-space management and routing of tuples; wherein feed-back information about resource bottlenecks is translated to key-space mapping; and (iii) a light-weight, fault-tolerant protocol for atomic route-map update.

By applying novel heuristics on the topology performance (feedback) metrics, advantageously the controller determines efficient route-maps, which encode tuple-routing information and also the topology link structure. These new route-maps are atomically injected into multiple operators, on-the-fly, using a light-weight, fault-tolerant protocol, for fast topology re-optimization. For the purposes of the discussion and disclosure herein, we illustratively implement our techniques, methods and protocols in Storm. Importantly, and in the context of three real applications, we demonstrate that techniques, methods, structures and protocols—according to the present disclosure—achieve the significant performance improvements over the prior-art namely, the 20% to 200% improvements—depending on the particular bottleneck.

Given the widespread use of streaming systems and the ubiquity of the dynamic system state in which they operate our techniques according to the present disclosure represent a significant and practical improvement in the performance of such systems.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect”. The aspects described above and other aspects of the present disclosure described herein are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 is schematic diagram depicting an example topology for flow control and fault tolerance in Storm;

FIG. 2 is a plot depicting the effect of choking a single random node wherein bandwidth is choked to 400 Mb/s at the 300 second mark, and to 200 Mb/s at 850 second mark, and completely unchoked at the 1400 second mark;

FIG. 3 shows sample reduction and broadcast trees generated by a Min Weighted Degree Tree (MWD) heuristic wherein (a) shows a complete digraph, (b) shows a reduction tree, and (c) shows a broadcast tree;

FIG. 4 shows a schematic of an atomic route-map update protocol according to an aspect of the present disclosure;

FIG. 5 shows a plot depicting the effect of choking a single random node wherein bandwidth is choked to 400 Mb/s at the 300 sec. mark, and to 200 Mb/s at the 850 sec. mark, and completely unchoked at the 1400 sec. mark;

FIG. 6 shows a plot depicting the effect of choking multiple nodes (complex congestion) at the 300 sec. mark, bandwidths are sampled from Normal (mean=700 Mb/s, sd=200 Mb/s), at the 800 sec. mark, bandwidths follow Normal (mean=400 Mb/s, sd=300 Mb/schematic of an LMS equalizer according to an aspect of the present disclosure;

FIG. 7 shows a plot depicting the impact of operator load skey wherein all sensors initially emit at a same rate (5 tuples/s) and at the 360 sec. mark, sensor emission rates follow Normal (mean=5 tuples/s, sd=5 tuples/s); according to an aspect of the present disclosure;

FIG. 8 shows bar graphs depicting varying model size(s) for in-bandwidth of a random node choked to 100 Mbit/s according to an aspect of the present disclosure;

FIG. 9 shows bar graphs depicting individual model sync times for in-bandwidth of a random node choked to 100 Mbit/s according to an aspect of the present disclosure;

FIG. 10 shows bar graphs depicting varying choked node bandwidth for model size=64 MB and Number of choked nodes=1 according to an aspect of the present disclosure;

FIG. 11 shows bar graphs depicting varying number of choked links for model size=64 MB and bandwidth choked to 200 Mbit/s according to an aspect of the present disclosure;

FIG. 12 shows a schematic block diagram of a stream processing engine operation according to an aspect of the present disclosure;

FIG. 13 shows an illustrative cloud-based stream processing architecture including controller and multiple sources of stream data including sensors, users, and databases according to an aspect of the present disclosure; and

FIG. 14 shows an illustrative controller architecture according to an aspect of the present disclosure.

The illustrative embodiments are described more fully by the Figures and detailed description. Inventions according to this disclosure may, however, be embodied in various forms and are not limited to specific or illustrative embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGURES are not drawn to scale.

We begin by again noting that stream processing applications for online analytics are increasingly being used in the rapidly expanding fields of sensor data processing and social networking—among others. To achieve the high-throughput required for such applications, stream processing engines employ pipelined execution and low-overhead, fault-tolerant, and highly-efficient group communication systems and methods.

As we have learned however, the throughput of pipelined application workflows is significantly impacted by the dynamic system states in which they operate. More particularly, a single bottleneck in the pipeline—for example a congested link or an overloaded operator—may dramatically impact overall system throughput.

In this disclosure we present a number of techniques—according to the present disclosure—for addressing such bottlenecks in stream engines. As will become apparent, our techniques according to the present disclosure include: 1) network-aware routing which advantageously provides fine grained control of streams and 2) dynamic overlay generation which advantageously optimizes the performance of group communication operations.

To enable fast work-flow re-optimization, we disclose a light-weight protocol for consistent modification of pipelines. We disclose detailed method(s), their implementation in a real system, and address issues of fault tolerance and performance and evaluate the performance of the techniques according to the present disclosure in the context of three applications.

Of particular advantage—and as will be readily appreciated by those skilled in the art—techniques according to the present disclosure improve performance by 20% to 200% under various overheads—relative to a baseline representative of current implementations. Finally, we disclose that our techniques according to the present disclosure are robust in a highly dynamic state, as well as complex congestion patterns. Given the widespread use of streaming systems and the ubiquity of the dynamic system state in which they operate our techniques according to the present disclosure represent a significant and practical improvement in the performance of such systems.

### Introduction

Stream processing engines (SE) such as Borealis, Samza, and Storm are widely used to process continuous streams of data originating from a variety of sources including distributed sensors, user-activity logs, and database transactions. Stream processing applications generally apply complex machine learning models to streaming data to derive useful information. Notably, a diverse set of applications have been successfully developed, including click-stream analysis, tracking malicious activity (spam classification, intrusion detection), real-time analysis of micro-blogs and tweets, and ad-click mining—among others.

Generally, stream engines code an application workflow as a directed acyclic graph (DAG) of operators, referred to as a topology. Tuples are processed in a pipelined fashion as they traverse through the topology. To achieve exactly a single processing of all tuples and to avoid buffer-overflows in the pipeline, stream engines adopt coarse-grained fault tolerance and flow-control mechanisms. As may be appreciated, when configured in this manner, even a single, slow stage of a pipeline affects the throughput of the entire pipeline.

To sustain high pipeline-throughput over long execution periods, it is necessary to dynamically detect and diagnose pipeline-bottlenecks. This is especially true for emerging online-learning applications which have complex topologies and often use structured overlays for group communication operations. In such an online learning application, learner operators process their respective partitions of an input stream (also called an example stream), and update their individual models. Concurrently, learner operators also synchronize their models periodically using group communication primitives—typically an all-reduce.

As compared to more traditional streaming workloads, online learning workloads exhibit the following distinct characteristics: (i) models may be large (tens to hundreds of megabytes), which leads to large state transfers between operators; (ii) complex, pipelined group communication (all-reduce) topologies are needed to synchronize potentially large state among all learners. Accordingly, the dynamic orchestration of complex topologies to maintain high throughput in the presence of bottlenecks requires novel techniques such as those described herein according to the present disclosure.

With the emergence of cloud-computing solutions, stream engines are often deployed on cloud-based virtual machines. Instead of stand-alone deployments, they co-exist alongside other compute and storage systems, such as MapReduce for batch processing and key-value stores for data. The orchestration of cluster resources among these systems is handled by a global cluster scheduler such as Mesos. In such deployments, stream engines experience network heterogeneity due to several factors including:
Co-hosted VM: Two or more virtual machines (VM) hosted on the same physical machine interfere in their network usage. The bandwidth observed by one VM depends on the traffic flowing into/from the other VM.
Co-hosted Framework: Cluster managers such as Mesos may allocate compute slots to at least two different frameworks—batchprocessing framework such as MapReduce, and a stream-processing framework—on the same physical machine or VM. This leads to network interference and uneven band-width availability to the different frameworks.
Co-hosted Topology: Even if only a stream processing system occupies an entire physical machine, multiple stream-topologies may be scheduled thereby leading to network interference. Furthermore, as SEs are deployed for long time periods, workload variations are commonly observed (e.g., activity of energy-measuring sensors exhibits temporal variation), leading to temporal skew in CPU utilization. Thus, for efficient stream processing, stream engines must effectively diagnose pipeline bottlenecks induced by heterogeneity with respect to computing and network resources.

Unfortunately, schedulers built for traditional SEs do not adequately cure those challenges posed by contemporary deployment and usage requirements. First, schedulers receive a static topology as input. However, for complex group communication operations such as all-reduce, the most efficient overlay structure depends on network and computing resources allocated to learner-operators. For at least this reason, current schedulers are unable to optimize complex communication structures, since they assume that the best topology is known a-priori. Accordingly, to detect and diagnose temporally varying pipeline bottlenecks, SEs must necessarily include a feedback-driven control loop.

Furthermore, a diagnosis phase—which involves changing the topology routes—should cause least disruption to stream engine tuple-throughput. And while certain techniques such as resilient substitution have been proposed as a general technique to scale or reassign topology operators, it is nevertheless an expensive operation, since it involves multiple steps including: 1) stopping the stream, 2) spawning new operators, 3) copying any necessary state from old operator(s), 4) refreshing network connections, and 5) re-starting the stream. As may be appreciated, frequent invocation of such high overhead techniques is impractical as they may significantly impact overall system performance.

Accordingly, our techniques according to the present disclosure namely, a per-topology controller, which uses novel methods and protocols according to the present disclosure for dynamic, network-aware routing and on-the-fly topology modifications.

We rely on three novel techniques to achieve network-aware routing: (i) representing topology link structure using route-maps; (ii) consistent hashing for fine-grained key-space management and routing of tuples; wherein feed-back information about resource bottlenecks is translated to key-space mapping; and (iii) a light-weight, fault-tolerant protocol for atomic route-map update.

By applying novel heuristics on the topology performance (feedback) metrics, advantageously the controller determines efficient route-maps, which encode tuple-routing information and also the topology link structure. These new route-maps are atomically injected into multiple operators, on-the-fly, using a light-weight, fault-tolerant protocol, for fast topology re-optimization. For the purposes of this discussion and disclosure, we illustratively implement our techniques, methods and protocols in Storm. Importantly, and in the context of three real applications, we demonstrate that techniques, methods, structures and protocols—according to the present disclosure—achieve significant performance improvements over the prior-art namely, 20% to 200% depending on the particular bottleneck. Furthermore, we demonstrate that our improvements are robust to highly dynamic network state, as well as complex congestion patterns.

### Motivation and Overview

We begin by describing a low-overhead method for flow-control and fault-tolerance employed by Storm. We then describe how pipeline-bottleneck problem(s) severely affect throughput, particularly with respect to mechanisms employed by Storm. Finally, we describe shortcomings of traditional schedulers in solving pipeline bottleneck problems and then describe how techniques, methods and structures according to the present disclosure advantageously solve these technical problems and the performance benefits that result.

### Flow Control and Fault Tolerance Mechanism in Storm

We begin by noting that Storm is a distributed, real-time computation system. Storm makes it possible to process unbounded streams of data. Storm—and stream processing in general—has many use cases. On a storm cluster, topologies are executed and process streams of tuples (i.e., data). The logic for realtime applications is packaged in a topology. A topology will generally run forever unless killed. Each topology is represented by a graph including spouts (which produce tuples) and bolts (which transform tuples). As noted—with Storm—a topology is a graph whose nodes are operators (spouts and bolts) and edges are virtual connections among operators. For simplicity, one may assume that every topology has a source operator (also called a spout).

A stream is one core abstraction in Storm. A stream is an unbounded sequence of topologies that is processed and created in parallel in a distributed manner. Streams are defined with a schema that names fields in the stream's tuples.

A spout is a source of streams in a topology. Generally, spouts will read tuples from an external source and emit them into the topology (e.g., a Kestrel queue or the Twitter API). Spouts can either be reliable or unreliable. A reliable spout is capable of replaying a tuple if it failed to be processed by Storm, whereas an unreliable spout forgets about the tuple as soon as it is emitted.

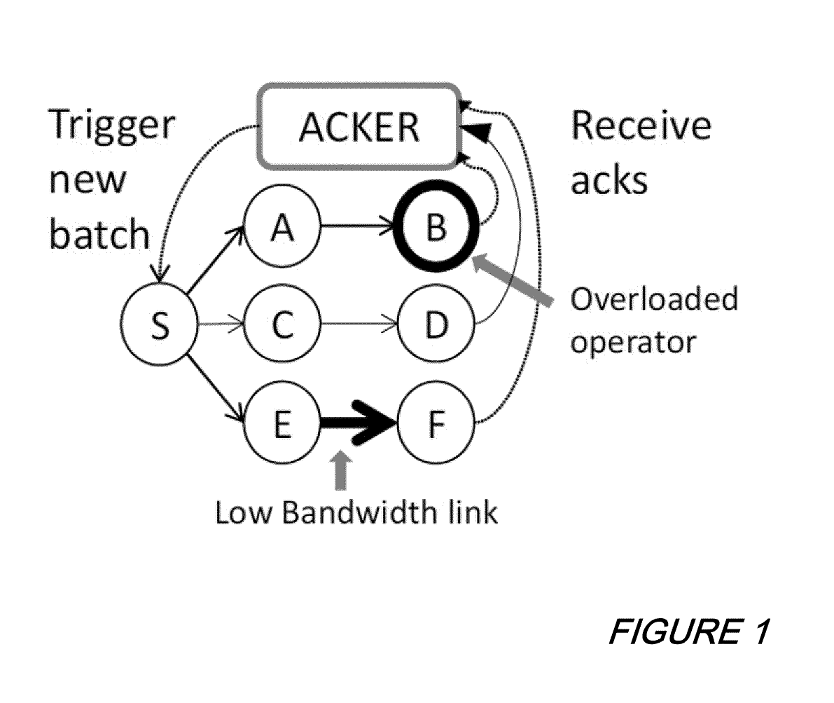

FIG. 1 shows an example topology. Tuples enter the topology through the spout. For every tuple (tups) that enters the topology, Storm tracks of all tuples that are emitted by bolts as an after-effect of observing tups. The emitted tuples are called descendents of tups.

When a bolt receives tups and emits tupd, it acknowledges same by sending ack tuples—one each for tups and tupd,—to a system managed Acker thread. The Acker thread calculates the XOR of all identifiers (extracted from ack tuples) that it receives. If the topology is a directed acyclic graph (DAG), a tuple's descendents form a bounded tree. In such cases, the Acker thread receives the identifier of every tuple twice, and XOR of all these tuple identifiers will result in a zero.

Upon observing a zero, the Acker thread marks the source tuple tups as successfully processed, and a new source tuple is allowed to enter the topology, leading to end-to-end flow control. If the Acker thread does not receive acknowledgements for all descendents within a user-defined threshold time interval, then it forces the source tuple (tups) to re-enter the topology, leading to re-processing of the entire descendent tree. This method guarantees at least-once processing of all tuples.

Building upon this basic technique, more stringent guarantees such as exactly-once processing of tuples can be achieved. To this end, tuples are split into batches with monotonically increasing identifiers. Once the Acker thread receives acknowledgements for all descendents created by tuples in a batch, it forces operators to commit the state created by that batch. During commit, the state is tagged with the identifier of the last observed batch. When a batch is replayed—owing to a fault in the system—the committed batch-identifiers are used to ensure that state is not updated twice by tuples of the replayed-batch.

### Drawbacks of the Flowcontrol Mechanism

The fault-tolerance mechanism described above exhibits low overhead, since it only requires a constant space per descendent tree (one variable for XORing all tuple-identifiers in a batch), irrespective of the number of tuples in the tree. However, the flow control aspect of the method is highly sensitive to rate of ack emission by different operators processing tuples in the batch.

Consider the topology shown in FIG. 1. Assume that the link between operators E and F exhibits a low bandwidth. This leads to low rate of tuple movement in S-E-F path of the pipeline. Consequently, the rate of ack emission by F is low. The Acker thread emits new batches into the system only after reception of acks from old-batches. Furthermore, a constant number of batches traverse the topology at any time. Notably, this method of matching sending-rate to the ack-rate is called ack-clocking in computer networks.

Due to the low rate of ack emission by F, ack-clocking ensures that tuples traverse S-E-F path with the rate dictated by the slowest segment (low-bandwidth link). This rate-matching avoids queue overflows and packet drops. However, since the Acker thread applies ack-clocking to entire batches, overall batch-emission rate decreases. Consequently, throughput of other pipeline-paths (S-C-D), with potentially high-capacity, also decreases. This leads to low-utilization of resources, and low system throughput.

Similar throughput decreases may be observed as a result of excessive processing delays at an overloaded operator (e.g., operator B in FIG. 1). Note that this phenomenon occurs even if the batch contains only one tuple, but is replicated and forwarded onto different topology-paths.

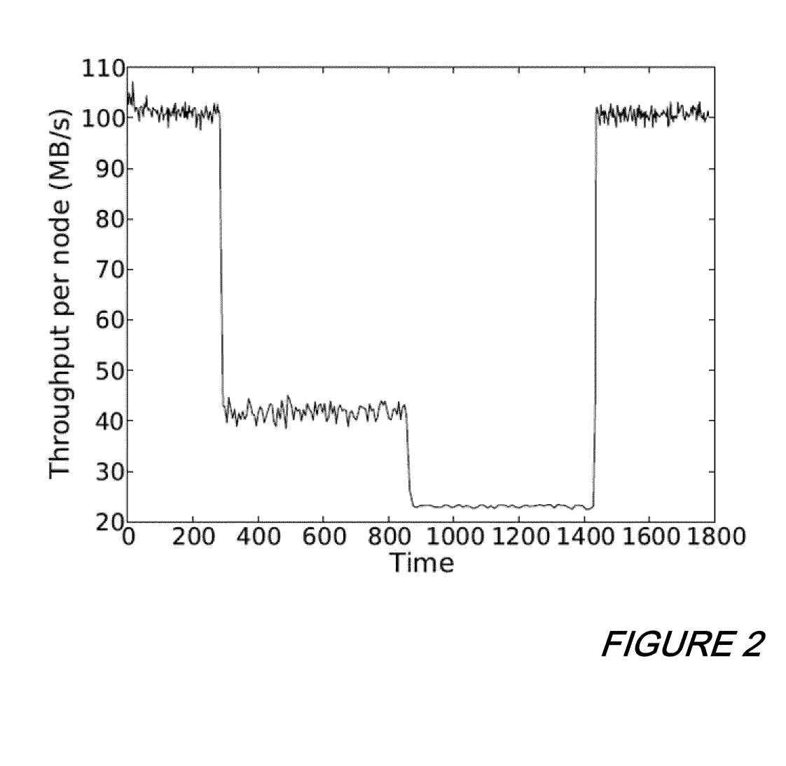

Turning now to FIG. 2, there it shows a throughput decrease observed in a tweet hashtag counting application, when receiver bandwidth of a randomly chosen node is dynamically varied. In the topology, one set of operators read tweets from external files and passes them to another set of counter-operators. All operators are placed on 16 nodes, ensuring a load-balance.

As may be observed by inspecting FIG. 2, topology throughput drops by more than 50% when bandwidth is reduced from 940 Mb/s (gigabit network) to 400 Mb/s. Also observe that the original throughput is restored when the link bandwidth is restored. This demonstrates how one choked link can cause throughput decrease in the entire topology, due to the coarse-grained ack-clocking mechanism. As may be appreciated by those skilled in the art, maintaining high throughput in the presence of conservative flow-control mechanisms requires dynamic, network-aware re-routing of data to balance load and increase resource (compute and network) utilization. Such is provided by methods according to the present disclosure.

### Overview of System

We disclose what we call “light-weight” methods for network-aware routing—according to the present disclosure—which are a combination of compute/network load-balancing, along with efficient topology re-optimization. Every operator chooses a destination operator for its outgoing tuples based on route-maps. Route maps contain information on the type and proportion of traffic for each destination operator. The per-topology controller periodically collects metrics from the system. Based on the observed bottlenecks, the controller computes new route-maps that minimize the maximum network and CPU utilization. The controller also determines route maps that tune complex all-reduction topologies. The resultant route-maps are installed in a consistent manner on a running cluster, using a light-weight atomic route-update protocol. One particular advantage of our solution is that it allows adaptive tuple routing at the sender operators, by providing feedback information about CPU and network conditions of downstream nodes.

### Dynamic Network Aware Stream Routing

In a stream-topology, tuples are communicated among operators running on compute nodes. We refer to grouping as the pattern of tuple-routing by a set of senders (upstream operators) to a set of receivers (downstream operators). A topology is expressed as a series of groupings between operators.

Two of the most common groupings observed in topologies include: (i) shuffle grouping: wherein upstream operators route each tuple to a random downstream operator; and (ii) fields grouping: wherein all tuples with the same values for a given set of tuple-fields—also called a key—are routed to the same downstream operator. Fields-grouping is used for aggregation or reduction of tuples with the same key.

### Factors Affecting Grouping Throughput

Several factors affect the grouping throughput—measured as the tuple processing rate of downstream operators. Those factors include:

Network Bandwidth Skew:

The available network bandwidth at downstream operators may be skewed. If the stream is network bound, the queuing delay at the operator with lesser bandwidth would significantly affect the grouping-throughput.

Per-Key Tuple-Count Skew:

In fields grouping, there may be a skew in the number of tuples per key—some keys—may be “heavy-hitters” meaning that they exert a significant influence. For example, in a sensor-processing application, some sensors could be more active than others. Consequently, even if keys are randomly hashed with a good hash function, the downstream operator receiving the tuples bearing the heavy-hitter key becomes a bottleneck.

Current systems, such as Storm, use modulo-based hashing to realize fields grouping. A tuple with key k is sent to the operator with index (i), where i=hash(k) % m, where hash denotes a hash function and m is the number of downstream operators. If the number of distinct keys is large, this method leads to good load-balancing among downstream operators.

However, in the context of many real applications, the method suffers from several drawbacks including:

Inability to Accommodate Downstream Skew:

As discussed, network bandwidth skew and per-key tuple-count skew affect the grouping-throughput. These criteria need to be incorporated in the routing strategy of upstream operators for efficient load-balancing among downstream operators. Modulo based hashing methods do not allow this flexibility.

Large Overhead while Scaling:

Consider the process of adding a new downstream operator. With modulo based hashing, many keys would be re-mapped to different downstream operators. If downstream operators contain state, key-remapping entails high-overhead state movement between operators.

Lack of Specificity:

It is not possible to assign a particular heavy-hitter key to a specific operator with more resources.

### Consistent Hashing

To avoid drawbacks of modulo-based hashing, we use a variant of consistent hashing. Consistent hashing was used in distributed hash table (DHT) implementations to accommodate frequent node additions and removals in peer-to-peer systems. In our case, we use consistent hashing primarily to encode the fine-grained information about changing network-capacities and workload imbalance among downstream operators.

In consistent hashing, keys are hashed into a range, say, —2³¹ to 2³¹−1, using a hash function. The range is divided into p contiguous partitions, termed as buckets. Assuming there are m downstream operators, initially, each downstream operator is assigned p/m buckets, chosen randomly without replacement. This random assignment leads to load-balance among downstream operators if the bucket count (p) is large and if all downstream operators have equal CPU and network capacities.

### Fine-Grained Resource Assignment

Random assignment of buckets to operators is not sufficient to account for fine-grained network bandwidth skew and per-key tuple-count skew, in fields-grouping. To this end, the controller periodically collects the following statistic for all buckets in all operators: per-bucket per-batch tuple-count, equal to count of tuples received by the bucket in the last batch. It also collects the following system metrics: i) CPU capacities of nodes (measured as millions of instructions per second (mips)); ii) network bandwidths (in and out) of all node-pairs; and iii) system throughput. The controller uses these metrics to increase the pipeline throughput by appropriately assigning the buckets to operators, which are hosted on physical nodes.

Since it is difficult to model the throughput of a complex pipeline, state-of-the-art schedulers attempt to load-balance the nodes while decreasing the amount of network traffic. In the same spirit, our controller first balances compute requirements of all pipeline stages by proportionately increasing the cpu-weight (share of total compute-capacity) of cpu-constrained stages. Later, it assigns buckets to operators so as to minimize the maximum CPU and network utilization.

For simplicity, assume every node has a replica of all different operator-types. In this setting, a bucket can be assigned to its operator-replica on any node. The resource assignment problem, formulated as an integer programming problem, is an extension of the one used by the COLA scheduler.

### Resource Assignment Problem Formulation

For both shuffle and fields grouping, each key-space partition forms a bucket. Let B denote the set of all buckets. If bεB is a bucket, D(b) denotes the computation rate (mips) used to process data received by b.

Let N denote the set of nodes. For a node nεN, C(n) denotes the computing capacity (mips) of the node. For any assignment of buckets to nodes, we set the decision variable x_{bn} to 1 if bucket b is assigned to an operator-replica on node n, otherwise it is set to 0.

Let S(n) denote the sum of compute-rates of all buckets assigned to n. In terms of the decision variables, S(n)=Σ_{b}x_{bn}*D(b). For buckets b₁, b₂εB, let F(b₁, b₂) denote the rate of data-flow between the two buckets in the stream topology. Using the decision variable, for nodes u, vεN, the rate of data flowing from u to v, can be defined as F(u, v)=Σ_{b}_{₁}_{,b}_{₂}_{εB}x_{b1,u}*x_{b2,v}*F(b₁b₂).

Let R(u, v) denote the actual bandwidth between the two nodes. The controller assigns buckets to nodes (specified by variables x_{bn}) based on the solution of the following integer program:

$$minimize {w}_{cu} * \overbrace{{max}_{n} S ( n ) \text{/} C ( n )}^{CU} + {w}_{nu} * \underbrace{{max}_{u , n} F ( u , v ) \text{/} R ( u , v )}_{NU} \\ subject to {x}_{b , n} ∈ \{ 0 , 1 \} ∀ b , n ; {Σ}_{n} {x}_{b , n} = 1 ∀ b \qquad ( 1 )$$

As may be readily appreciated by those skilled in the art, an objective of the problem is to minimize a weighted function of two quantities: i) CU: maximum observed CPU utilization; and ii) NU: maximum observed network utilization.

The controller also has another competing goal of reducing the total inter-node traffic (Σ_{u,vεN}F(u,v)). Similar to COLA, we use a combination of a graph partitioner and load-balancing heuristics to obtain a feasible solution.

For large problem sizes (bucket-count is large), graph partitioners are computationally expensive. In such cases, we implement a recently proposed re-streaming algorithm for multi-constraint graph partitioning, which is shown to be competitive with offline-graph partitioners while using limited resources.

At this point, we note some particularly distinguishing aspects of our formulation according to the present disclosure as compared to the COLA scheduler. Those particularly distinguishing aspects including: i) modelling traffic as data received by fine-grained key-space buckets instead of coarse-grained operators which allows fine-grained mapping of buckets to nodes, leading to balanced-load even in the presence of per-key tuple count skew; and ii) balancing utilization of all network links is added to the objective function which is very important in environments where network capacity may exhibit significant variations over time.

### Accuracy of Network Bandwidth Estimates

Measuring available network bandwidth between nodes in a cluster already running a stream-processing engine is a challenging problem for at least two reasons: i) the data-sent by measuring tools, such as IPerf, interferes with the stream-traffic, thereby returning noisy bandwidth estimates; ii) due to the interference from measurement-traffic, the stream throughput drops during the measurement-period.

To avoid these overheads, and according to the present disclosure, the controller primarily uses bandwidth estimates inferred from the rate of tuple-acks emitted by different nodes in the past time-windows. It uses measuring tools for metrics are in-sufficient. Also note that the assignment problem only requires relative bandwidths, instead of accurate values. To avoid frequent bucket re-assignment, the controller invokes the control loop only when hysteresis-applied system throughput (rate of tuple-ingestion by the spout) in the recent time windows drops by a threshold percentage (default: 10%) when compared to the long term average.

Furthermore, the controller first checks for CPU load imbalance. Once the controller discards the per-key tuple-count skew as the cause of throughput-decrease, it checks for the network bandwidth skew. These policies decrease the usage-frequency of noisy bandwidth estimates, and also help set appropriate weights in the multi-constraint load-balancing heuristics.

The output of the resource assignment problem is a mapping of buckets to operators, referred to as route-maps. Using these route-maps, in modified shuffle-grouping, upstream operators choose a random downstream bucket, instead of a downstream operator, when routing tuples.

### Topology Reoptimization for Intermediate Routing

### Need for Group Communication Operations

Group communications operations, as exemplified by an all-reduce operation, are used by many distributed online learning applications. These operations typically rely on structured static overlays for orchestrating data movement. We now describe a method (algorithm) according to the present disclosure for determining spanning tree overlays for pipelined all-reduce operations, which explicitly accounts for dynamic network-state.

In an online learning application, operators that train the model using training—examples are termed “learners”. For accurate model training, the model (in our case of a stochastic gradient descent, also called a weight vector) is periodically synchronized among learners, using an all-reduce operation. Static binary trees are among the most commonly used overlays in systems for pipelined all-reduce group communication.

Each learner divides its weight vector into slices. Each slice traverses up the tree during reduction and down the tree during broadcast. The tree structure is effective for pipelining slices of a large model or for sending complete models in quick succession, as the network links in a tree allow un-congested traffic flow. However, the throughput of a pipelined tree is heavily influenced by the slowest link. In streaming systems, since model synchronization traffic flows alongside the regular example traffic (input tuples used to train models), the available bandwidth on different links may vary significantly. In this scenario, the tree overlay must be dynamically optimized to suitably use links with higher available bandwidth.

Furthermore, in a tree, different nodes (learners) emit their model and receive the reduced model at different times. In this scenario, tree overlays must ensure that low-bandwidth links do not significantly impact model synchronization times for all of the nodes. With these high-level goals, we first define a few terms and formally state the problem. We then describe our methods according to the present disclosure for dynamic computation of efficient overlays.

### Problem Formulation

Let G be a complete directed graph, where nodes denote machines hosting learner operators and edges represent potential overlay links. The directed edge-weight between nodes s and d is W_{s,d}, which is the time taken to transmit a byte of data from s to d (inverse of link bandwidth).

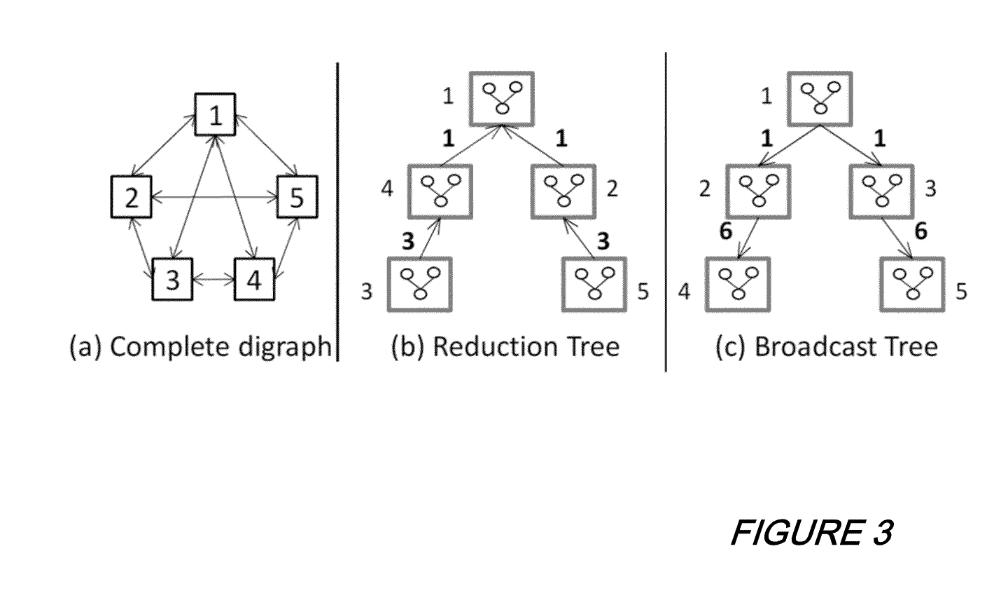

FIG. 3 shows a sample reduction tree (b), and a sample broadcast tree (c), generated from the same graph, (a). Let tₛ(i) denote the start-time for model synchronization at node i. This is the time when node i attempts to reduce its first model-slice with the corresponding model slices received from its children. Node i subsequently sends the reduced model-slice to its parent in reduction tree.

Let tₑ(i) denote the end-time for model synchronization at node i. This is the time when node i receives the last reduced model slice from its parent in broadcast tree. Let tₘₛ(i) denote the model synchronization time for node i, defined as tₑ(i)−tₛ(i). The problem statement can now be defined as:

Problem Statement:

Generate a spanning tree for pipelined all-reduce that minimizes the average model synchronization time, over all nodes.

$$minimize ( \frac{1}{\vert N \vert} ) * {Σ}_{i ∈ N} {t}_{ms} ( i ) \qquad ( 2 )$$

In message passing (MPI) systems, overlays are chosen to minimize the maximum completion time of a group communication operation. In contrast, we focus on optimizing the average completion time. This is because, in streaming systems, group communication operations do not follow barriers; they are triggered periodically irrespective of the completion of the previous operations. Furthermore, in online learning applications, average completion time is also an indirect measure of model mixing-rate.

We extend the Min Weighted Degree Tree (MWD) heuristic to generate both pipelined broadcast and pipelined reduction trees.

Pipelined all-Reduce Overlay Generation

The method according to the present disclosure is shown in the following program listing, Algorithm 1. To compute a broadcast spanning tree topology, Min Weighted Degree Tree (Algorithm 1) works as follows: Initially the spanning tree contains only the root node. In each iteration, the algorithm adds the least weighted out-edge (intuitively, the fastest outlink), say (u, v), to the spanning tree. The edge-weights of all other outgoing-edges from node u that are not already in the spanning tree are incremented by the time node u spends in broadcasting to the previously chosen children. This time is equal to sum of edge-weights to current children (Σ_{v′children(u)}(W_{u,v′})). The algorithm continues to select edges until all nodes are included in the spanning tree. When selecting edges, nodes in the spanning tree that have less than a preset threshold k edges are given preference. Advantageously, this parameter can be tuned to generate trees with different branching factors.

Algorithm 1 Min Weighted Degree Tree

| | |
|---|---|
| 1: | procedure Min-Weighted-Degree-Tree(V, vₛ, E, T, b, TreeType) |
| 2: | TreeEdges ← |
| 3: | TreeVertices ← {vₛ} |
| 4: | for each e = (u, v) ∈ E do |
| 5: | cost(u, v) ← T_{u,v} |
| 6: | end for |
| 7: | while TreeVertices ≠ V do |
| 8: | if TreeType = BroadcastTree then |
| 9: | ReadyVertices ← {u ∈ TreeVertices \| \|children(u)\| < b} |
| 10: | ReadyVertices ← {u ∈ ReadyVertices\|Distance-From-Root(u) is the least} |
| 11: | link(u, v) ← {u ∈ ReadyVertices,v ∉ TreeVertices\|cost(u, v) is the least} |
| 12: | TreeVertices ← TreeVertices ∪ {v} |
| 13: | TreeEdges ← TreeEdges ∪ {(u, v)} |
| 14: | for each edge (u, w) ∉ TreeEdges do |
| 15: | $cost ( u , w ) ← {\sum }_{{v}^{′} ∈ children ( u )} ( {T}_{u , {v}^{′}} )$ |
| 16: | end for |
| 17: | end if |
| 18: | if TreeType = ReductionTree then |
| 19: | ReadyVertices ← {u ∈ TreeVertices \| \|children(u)\| < b} |
| 20: | ReadyVertices ← {u ∈ ReadyVertices\|Distance-From-Root(u) is the least} |
| 21: | link(u, v) ← {u ∈ ReadyVertices,u ∉ TreeVertices\|cost(u, v) is the least} |
| 22: | TreeVertices ← TreeVertices ∪ {u} |
| 23: | TreeEdges ← TreeEdges ∪ {(u, v)} |
| 24: | for each edge (w, v) ∉ TreeEdges do |
| 25: | $cost ( w , v ) ← {\sum }_{{u}^{′} ∈ children ( v )} ( {T}_{{u}^{′} , v} )$ |
| 26: | end for |
| 27: | end if |
| 28: | end while |
| 29: | return TreeEdges |
| 30: | end procedure |

To generate spanning tree for all-reduce, we use the MWD heuristic (Algorithm 1) to first find a reduction tree, starting from a given root (v). Since it is a reduction tree, edges coming into the spanning tree (in-edges) are considered when choosing the min-edge. After the reduction spanning tree is generated, its edges are removed from the graph. The algorithm is now run on the residual graph to generate a broadcast tree with the same root node (v). The average synchronization path length, over all nodes, is calculated using the generated reduction and broadcast trees. The algorithm repeats the above steps, each time with a different node as the root of spanning tree. The final chosen root node is the one with the least average synchronization path length, and the final reduction and broadcast trees are the ones generated by the chosen root node. Inside each node, one learner operator is chosen as leader and all other learners are connected to it. The leader reduces the model slices generated by node-local learners before sending them to other nodes. It also performs node-local broadcast.

Using Fibonacci heaps for edge-set implementation, the algorithm takes O(|E|+|V| log |E|) to generate reduction and broadcast trees for a chosen root, where E is the set of edges and V is the set of nodes. The algorithm is invoked |V| times, one for each chosen root node.

Algorithm MWD has a number of desirable properties. The greedy heuristic builds pipelined spanning trees with low weighted out-degree (sum of out-edge weights) of any node in the broadcast tree; correspondingly low weighted in-degree of any node in reduction tree. This strategy minimizes the choking effect of any one stage in the pipeline.

Before generating the broadcast tree, the algorithm removes the edges used for reduction tree. This eliminates the possibility of a single link being used for both reduction and broadcast. The final chosen root is one that reduces the average model synchronization time of all nodes. Intuitively, the heuristic pushes the congested links closer to the leaves than the root, because a congested link close to the root will lie in the synchronization path of a large number of nodes, thereby increasing their synchronization time.

In FIG. 3 node 5 exhibits low in-bandwidth. Therefore, the heuristic places it among leaves, avoiding its choked bandwidth from affecting the entire pipeline. Furthermore, if node 5 was made the root, it would receive the model-traffic from two children. This extra traffic further decreases the bandwidth for the concurrent training-example traffic, thereby increasing the choking-effect of that node.

A linear tree, generated by setting k to 1, has better pipeline bandwidth than binary tree (k set to 2). Assuming n nodes in total, in linear tree, n−1 nodes are involved in reduction. Even if one of these nodes has less in-bandwidth, it chokes the entire pipeline. Furthermore, for small-sized models, or when the change in model since last synchronization is small, linear tree performs poorly as it takes time proportional to O(n). On the other hand, binary trees have comparatively less pipeline bandwidth, but offer two benefits: i) since only n/2 internal nodes are involved in reductions, ill-effects of choked nodes (upto n/2) can be localized by placing them among the leaves; ii) binary trees perform well even for small models due to O(log n) height. Therefore, methods according to the present disclosure choose binary trees by default. Ternary tree (k is 3) can be used when there is considerable skew in node capacities, since only n/3 nodes form internal nodes.

### On the Fly Topology Modification

So far we have described methods for dynamically changing key-space assignment and overlay topologies. Another novelty in methods according to the present disclosure lies in the method for updating routing information at operators to reflect the changes proposed by the controller.

### Route Maps as Topology Route Specification

Each operator maintains a route-map that specifies the routes on which output messages should be sent after processing incoming messages. For instance, to specify an all-reduce topology, each route-map entry would be of the form: receive from: [1, 2, 3], send-to: [4, 5, 6]. This implies, the operator should wait for input message reception from operators with ids: 1, 2 and 3, before sending the output message to operators with ids: 4, 5 and 6. A sample route-map entry to specify fields or shuffle grouping would be: send-to: [10,344]: [1], [5677, 34345]: [2]. It denotes the assignment of key-space partitions to downstream operators.

### Atomicity Requirements

To change a running topology on-the-fly, route-maps of all involved operators must be updated in an atomic manner—i.e., all nodes must switch to the new route-maps at the same time. For example, if upstream operators route tuples based on different route-maps, two tuples with same keys may not reach the same downstream operators, thereby violating the semantics of fields-grouping. Similarly, overlay modification needs to be atomic. If only a sub-set of the nodes have received new route-maps and the other nodes are using the old route-maps, then the resultant topology may not satisfy reduction semantics. To this end, we describe—according to the present disclosure—a “light-weight” protocol for modifying topology route-maps in an atomic manner. We focus on updating the route-maps with least possible interruption to the existing stream traffic.

### System Constraints

As described previously, Storm uses a global acknowledgement mechanism to deal with both network-error and operator-failures during tuple traversal.

### Fail Fast Operators

Operators in a Storm topology are fail-fast. That is, unlike database nodes that log all their actions into a write-ahead-log, storm operators do not log all input tuples and their corresponding outputs. Only designated operators containing state can checkpoint their local state at batch-boundaries. This design helps in quick re-spawning of a failed operator on another node without the overhead of processing any undo or redo logs. In case of operator failure, the global fault-tolerance mechanism ensures re-delivery of unprocessed tuples. This fail-fast design, unfortunately, does not permit the use of traditional atomic commit protocols such as 2-phase or 3-phase commit protocols, which rely on local write-ahead-logs for participant recovery.

### Atomic Route Map Update Protocol

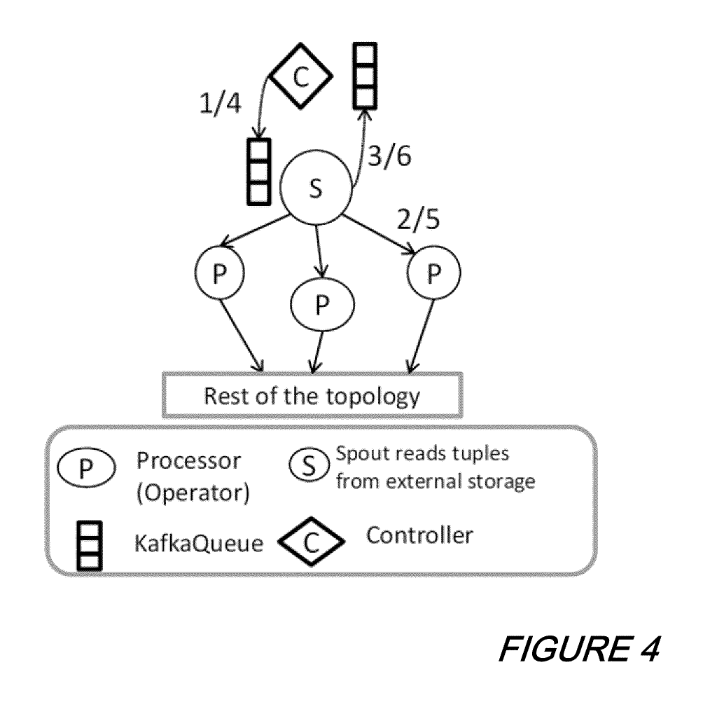

We describe a six-step protocol according to the present disclosure to assure atomic route-map update. As shown in FIG. 4, for every topology, there exist two components: a controller (part of the scheduler) and a spout; both these components have corresponding kafka queues, which form their message sources.

The spout has the following functionality: (i) it truncates the stream into batches and demarcates them by appending start-batch and end-batch tuples to the stream at batch-boundaries; and (ii) it emits tick-tuples to trigger time-based windowed reductions. Truncating the stream into batches permits the use of global fault-tolerance mechanisms. Note that start-batch and end-batch tuples traverse the entire topology DAG starting from the spout. Tick-tuples are used to periodically trigger all-reduce (or windowed aggregation operations) on all operators. To update route-maps, the controller creates new routemaps for each involved operator, tags the new maps with a version number (which increases monotonically), and executes the following six-step protocol.

1) Controller first stores the new route-maps in its local state, durably stored in zookeeper. Later, it sends the new route-maps message, tagged by a version-id, to the spout (S), by placing it in the latter's kafka queue.

2) Spout reads the new route-maps from its kafka queue, appends an install-routes command to the message, and sends it to all the involved operators by piggybacking on the next start-batch tuple. The spout waits for acknowledgements from involved operators; this happens through Storm's Acker interface. On reception of route-maps, operators do not immediately switch to the new route-maps; they simply append it to their list of route-maps.

3) After receiving acknowledgements from all operators, the spout sends a routes-installed confirmation message to the controller by placing it in the latter's kafka queue.

4) On reception of the routes-installed message, the controller durably stores the new topology-route-maps in its local-state. As the controller is part of the scheduler, this local-state is stored in zookeeper. The controller now sends a activate-new-routes message to the spout by placing it in the latter's kafka queue.

5) On receiving the activate-new-routes message, the spout first appends the received message onto the next start-batch tuple. The controller then waits for the successful commit of all currently executing batches before sending the piggybacked start-batch tuple. Since all operators start using the new route-maps for the same batch, semantics of grouping and reduction among operators is consistent.

6) Once the spout receives all acknowledgements for the start-batch tuple containing activate-new-routes message, it sends an activated-new-routes message to the controller, by placing it in the latter's kafka queue. When the controller receives the message, it marks the successful completion of the protocol.

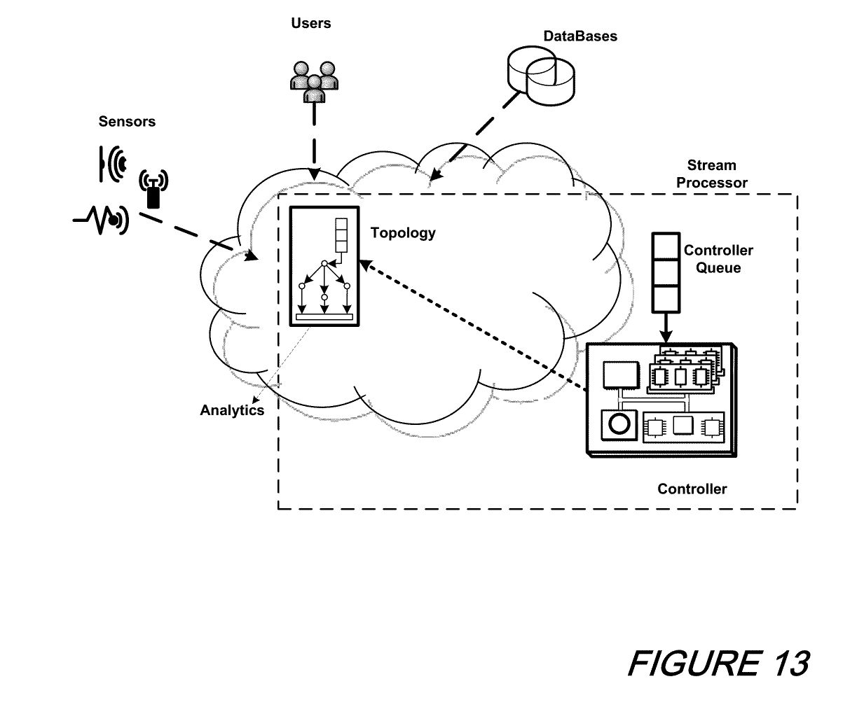

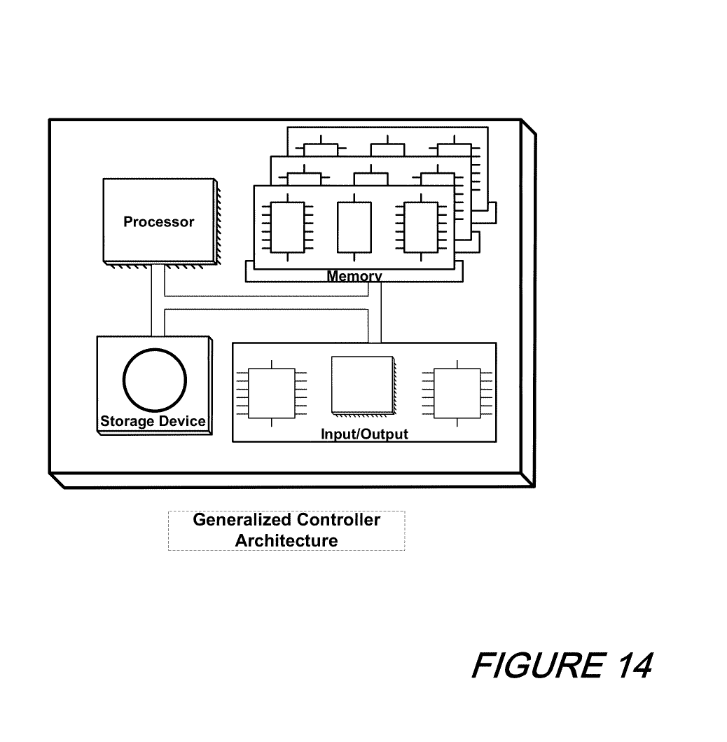

We note at this point, and with simultaneous reference to FIG. 13 and FIG. 14, shown therein is the exemplary systems described with respect to FIG. 4, in the context of a cloud-based stream processing system. As shown therein, data streams originating from—for example—sensors, users, databases, etc are directed to cloud based stream processing systems where they are stream processed. We note that while we have depicted this system as being cloud-based, such systems could be premises based if implementation requirements so dictate. Additionally, we emphasize the role of the controller in this illustrative Figure, as it is the controller in which our methods according to the present disclosure may operate. FIG. 15 depicts one illustrative controller architecture which as we have noted, may be cloud resident or premises based. As may be appreciated, the architectures depicted in these Figures are only illustrative, and the we submit that most any architecture able to execute the topologies contemplated by this disclosure are useful for our purposes.

### Correctness of the Protocol

We prove the correctness of the protocol by showing that it does not violate the following safety properties.

No Duplicate State Changes:

Two operators must not update the state for the same key-space bucket in a batch. Our protocol ensures this property since every batch adopts a single route-map version, and all operators operating on a batch follow the same route-map.

Access to Complete State:

Once an operator assumes ownership of a key-space bucket, it must have access to all the state previously generated for that bucket. This property enables owner operator to process all queries involving keys in its assigned bucket. The protocol satisfies this property as new routes are activated only after ensuring that all previous batches have committed. Therefore, the new owner of the bucket can fetch any needed state from the persistent store while answering queries.

Consistent Group Communication:

For reduction among operators, the spout ensures that all the emitted tick-tuples fall into the same batch. This ensures that all operators follow the same route-maps for reduction.

### Protocol Fault Tolerance

This section describes the mechanisms used by the protocol to handle tuple and operator failures at various steps.

### Route Installation Phase

The route installation phase is marked complete only after the controller read the installed-routes message from the spout and subsequently stored all the versioned route-maps in zookeeper. If installation fails before this point, the controller times-out and retries the installation phase. The controller ensures that the protocol does not move to the activate-new-routes phase until the previous route-installation phase successfully completes. This ordering ensures that all operators are aware of the new routes before any of them starts to send messages along new routes.

Three types of faults are possible: spout failure, operator failure, or tuple loss due to network failure. If spout fails, then the controller times-out and retries the phase. In the event of operator failure or tuple loss, the spout times-out in receiving the acknowledgements, and re-tries the installation phase by piggybacking on the next start-batch tuple.

### Route Activation Phase

Since route-activation is piggybacked on start-batch tuples, any operator failure manifests as a regular topology failure. The system reacts to operator failure in two ways: (i) the controller re-spawns the operator with all the latest route-maps information. Since controller is in route activation-phase it is guaranteed that all other live operators have the latest route-maps; and (ii) if the spout emitting the stream tuples times-out, it re-emits the batch tuples. Since, every start-batch tuple carries the route-map version number that the operators are required to follow, each operator will follow the correct route-map during next aggregation/reduction.

### Controller Failure

The controller always logs its topology modification related actions in zookeeper. This is done to make it fail fast. Thus, re-spawning the failed controller is a sufficient fault-tolerance mechanism for the protocol to progress. The re-spawned controller will work-off the state stored in zookeeper. Furthermore, it reads the pending message from its kafka queue. For this reason, it can never miss any messages. Since communication between the spout and the controller always takes place through durable kafka queues, message loss in that communication channel is not possible.

### Need for Two Phases

The first phase (route-map installation) is used to ensure two conditions: (i) all involved operators have sufficient resources (memory capacity, connections to new, scaled-out operators, etc.) to exchange buckets as dictated by new route-maps; and (ii) all operators have the new route-maps. Once these two conditions are satisfied, the second phase (route activation phase) can atomically switch to new routes without any system-level interruptions.

### Experimental Evaluation

We present a comprehensive evaluation of two of the techniques describe herein according to the present disclosure namely, 1) dynamic routing for solving problems associated with overloaded network-links/cpu; and 2) adaptive overlays for group communication. One aspect of the evaluation is to demonstrate the effectiveness and robustness of our disclosed techniques. Our evaluation was conducted on a 30-node cluster wherein each node includes a 2.4 GHz quad-core Xeon processor with 8 GB of RAM, connected via gigabit ethernet links.

### Static Versus Dynamic Topologies—Applications

To compare the performance of static and dynamic (network-aware routing) topologies, we implemented three representative streaming applications from different domains: (i) hashtag counting on tweets; (ii) a malicious url detection algorithm, representative of an online learning application; and (iii) stream analytics on sensor measurements from DEBS 2014 grand challenge.

In hashing counting application, tweets are emitted to random counter-operators which maintain a count of unique hashtags observed in tweets. The application mainly uses shuffle-grouping. In the malicious url detection application, the learner operators train a linear model using incoming (shuffled) spam urls from multiple sources: tweets, emails, blacklists, etc. For training, each learner runs regularized logistic regression implemented in vowpal-wabbit using stochastic gradient descent (SGD). Learners synchronize their models (weight vectors) through all-reduce operations using a spanning tree overlay imposed on the learners.

Notably, other online learning applications have reported weight vectors for 20 million features. To study the performance of reduction pipelines on weight vectors of varying sizes, we introduce appropriate random features into the dataset. This application mainly uses shuffle-grouping and all-reduce overlays.

The sensor analytics application addresses analysis of energy consumption measurements from sensors deployed in a smart grid. The load prediction query forecasts the energy demand of a smart plug in the near future based on measurements sent by its sensor in a past time-window. Another query detects outliers among the smart plugs based on their past usage. Both queries use fields-grouping for time-windowed processing of measurements from a particular sensor.

Two issues manifest in a stream-engine that processes measurements from a large number of sensors. The rate of emitted measurements across different sensors is prone to skew: temporal skew occurs when sensors in one continent do not emit observations (during night-time) while sensors in other continents are active; spatial skew occurs when some sensors emit frequent measurements due to heavy usage. Fine-grained tracking of bucket (key-space) load is key to handle throughput loss due to skew.

### Effect of Link Congestion on Static and Dynamic Topologies

To test the effect of dynamic network-aware routing, we randomly choose certain nodes hosting counter-operators (in hashtag counting app) and decrease their in-bandwidth using traffic control (TC) and intermediate functional block (IFB) tools in linux. The controller detects the choked receiver via the metrics interface. Subsequently, the controller creates new-route maps and installs them in the topology.

### Impact of Dynamic Congestion

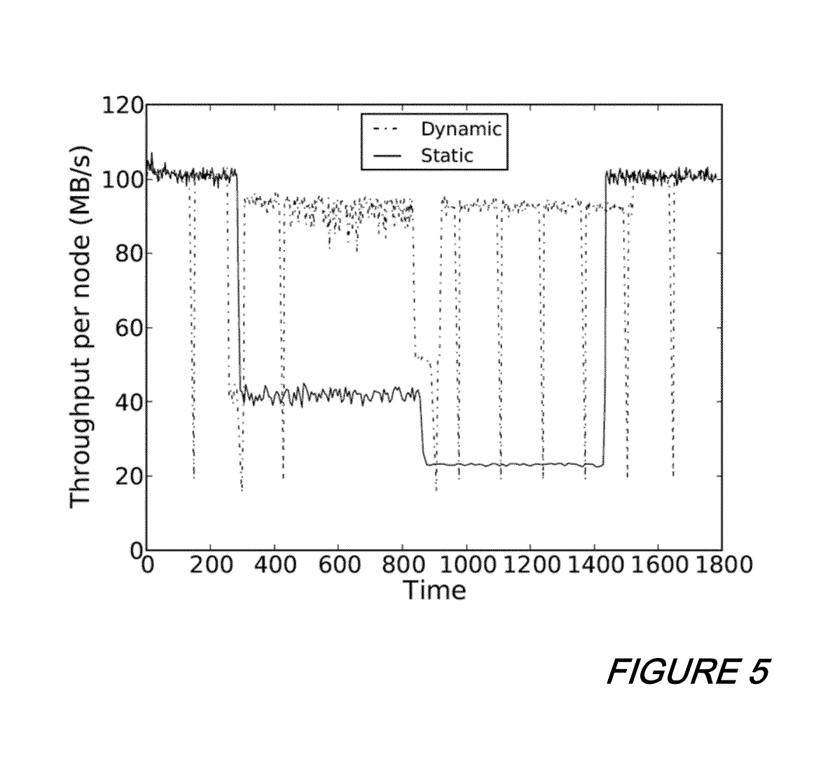

In this set of experiments, we investigate the response behavior of the controller when one link-state is dynamically varied. Here, a random learner is chosen and its in-bandwidth choked according to the following pattern: at the 300 sec mark, the in-bandwidth is choked to 400 Mb/s; at 850 sec mark, it is choked to 200 Mb/s; at 1400 sec mark, it is unchoked to its full gigabit bandwidth. FIG. 5 is a plot that shows the effect of choking a single random node wherein the bandwidth is choked to 400 Mb/s at 300 sec. and to 200 Mb/s at the 850 sec mark and completely unchoked at the 1400 sec mark. The plot depicts throughput-per-node (volume of input tweets processed per node) as a function of time, for the hashtag counting application. Results for the other two applications showed a similar pattern. For static overlays, once choking sets in, throughput drops significantly (almost 60% for 400 Mb/s and 80% for 200 Mb/s), even though only a single link is choked. In the case of dynamic overlays, once the controller detects throughput loss and new route-maps are incorporated into the topology, we observe a substantial increase in overall throughput. After 400 Mb/s choke, throughput returns to 95 MB/s from 45 MB/s, corresponding roughly to 200% increase in throughput. For 200 Mb/s choke, performance increases by almost 300% when choked link utilization is reduced. Our experiments demonstrate that network-aware routing can be used to recover a substantial part of this lost performance. Note the downward spikes (intermittent loss of throughput), in the dynamic case. They coincide with the times when the controller triggers either network bandwidth measurements or new route-map installation, after observing changes in system throughput. Activation of new route-map requires flushing of current batches to avoid semantic inconsistencies. The loss in throughput for a brief time window leads to more accurate load-balancing and consequent increase in throughput over the long-term. Furthermore, due to hysteresis in measurements, the controller takes a while to react to loss in system throughput. The reaction time of the controller can be tuned by adjusting the hysteresis parameters.

It is important to note that while performance improvements from dynamic, network-aware routing are substantial, it could not completely regain the lost throughput. This is due to two reasons: i) the measure of available-bandwidth at learners is not very-accurate; and ii) the stream-traffic removed from the choked nodes is now processed by the other nodes, along with their own traffic, thereby increasing the total batch-processing delay.

### Impact of Complex Congestion Patterns in Link State

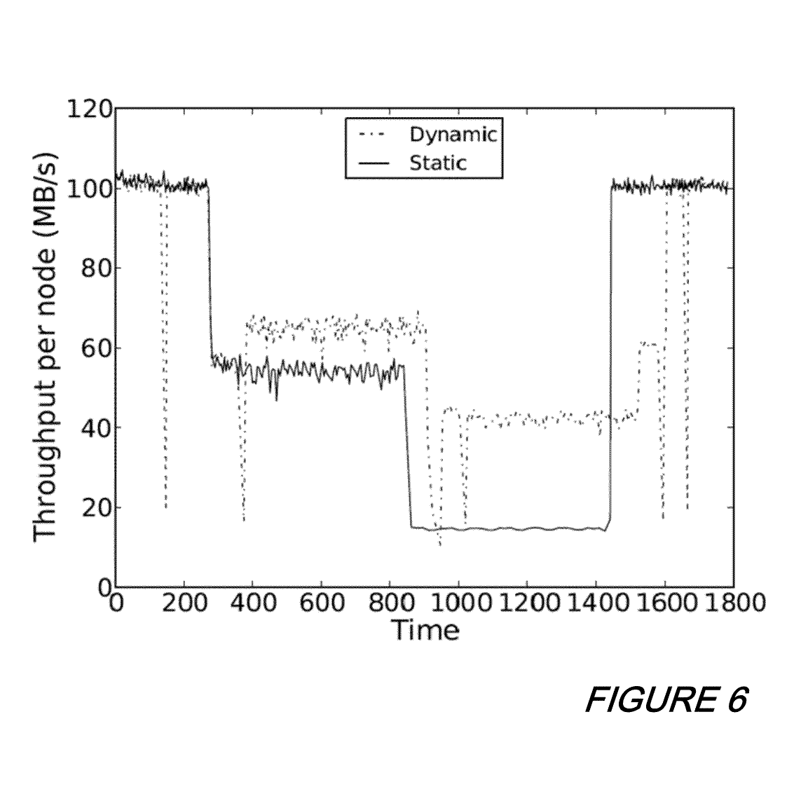

To realize complex congestion patterns typically observed in cloud settings when the system runs for long time periods, we choke nodes based on sampling a distribution. FIG. 6 shows the performance of static and dynamic topologies under multi-node complex congestion pattern. At 300 sec mark, in-bandwidths are sampled from a normal distribution (mean=700 Mb/s, sd=200 Mb/s). At 800 sec mark, bandwidths follow normal distribution (mean=400 Mb/s, sd=300 Mb/s). At 1450 sec mark, all nodes are unchoked.

As is evident from the results, when the standard-deviation is large (300 Mb/s), the improvement in throughput is large (more than 50%). This arises due to the need for accurate load-balancing between slow and fast links. When standard deviation is small, the difference between in-bandwidths is not significant. Consequently, the need for dynamic loadbalancing diminishes and the performance gains are commensurately lower.

### Impact of Skew in Per-Key Tuple Count

To test the impact of CPU load imbalance created byper-key tuple count, we use the sensor-analytics application, which relies on fields-grouping for analyzing the pattern of individual sensor measurements over a time-window. We create skew among sensors by sampling their measurement emission rates from a normal distribution.

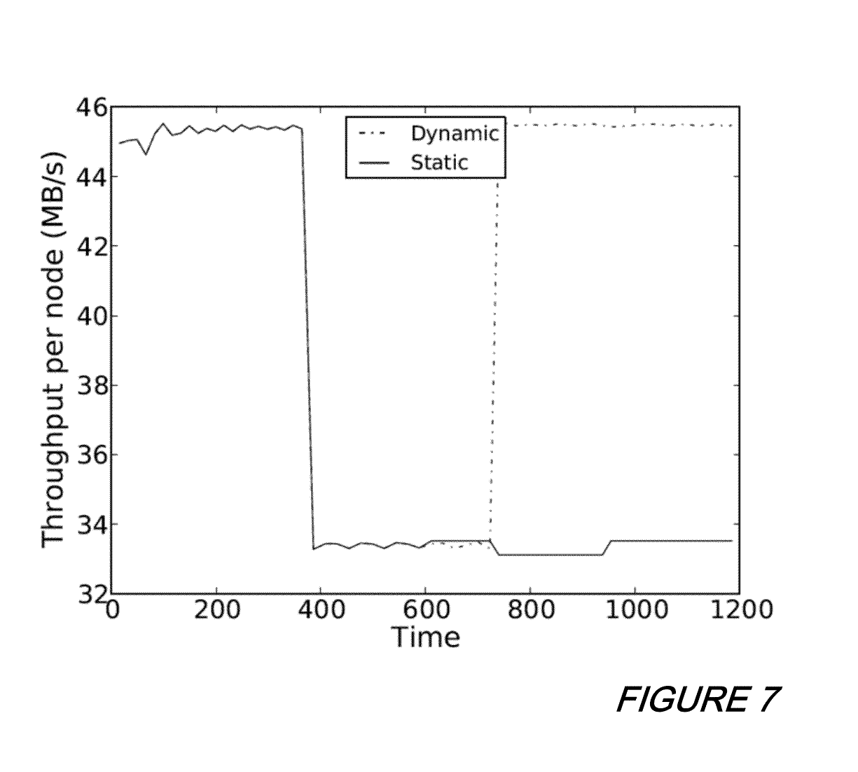

FIG. 7 shows the throughput increase due to fine-grained balancing of tuple-skew by the controller. At the 250 sec mark, the rate of sensor-measurement emission is sampled from a normal distribution(mean=5 tuples/s, sd=5 tuples/s). The small number of nodes hosting the sensors with high rate of emission, process more data, adding extra delay to the batch-pipeline. The controller detects the reduced throughput and triggers load-balancing of the fine-grained key-space buckets, leading to sensor re-assignment Throughput improves by more than 20% after bucket reassignment.

The above results show the benefit of fine-grained tracking of per-sensor activity via key-space bucket monitoring. Consistent hashing enables fine-grained key-space partitioning, which is needed to track, diagnose and rectify skewed sensor activity. Selective bucket re-assignment leads to selective-sensor allocation to nodes.

### Performance of Dynamic Overlays on Group Communications

In typical learning applications, learners periodically communicate to synchronize their models. In the following set of experiments, we compare the average model synchronization times observed in spanning tree overlays obtained through two techniques: a random, static binary tree (baseline) and the proposed MWD approach. In each case, we quantify the impact of link congestion on performance.

Performance Improvement from MinWeightedDegree (MWD) Approach for Varying Model Sizes

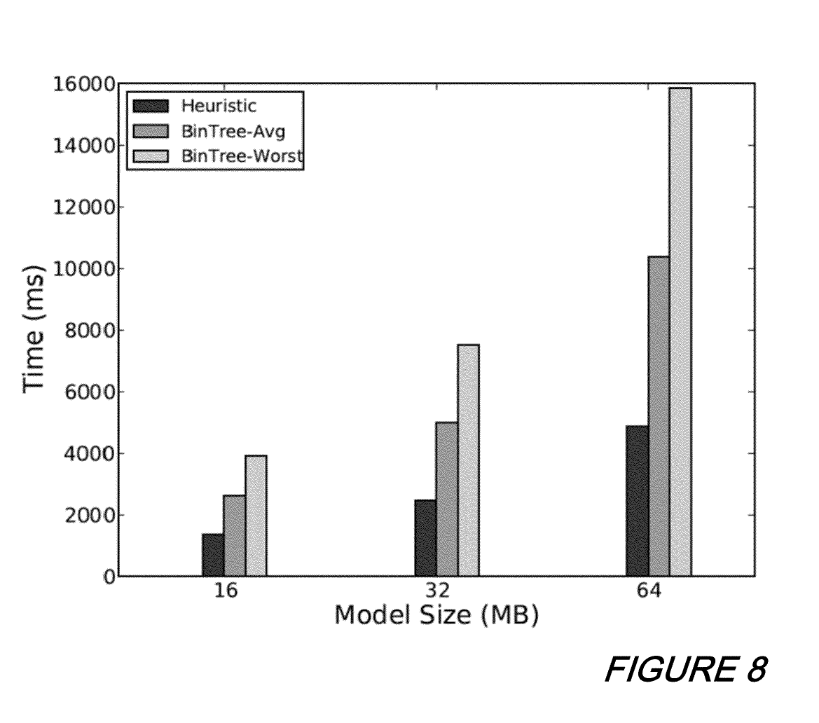

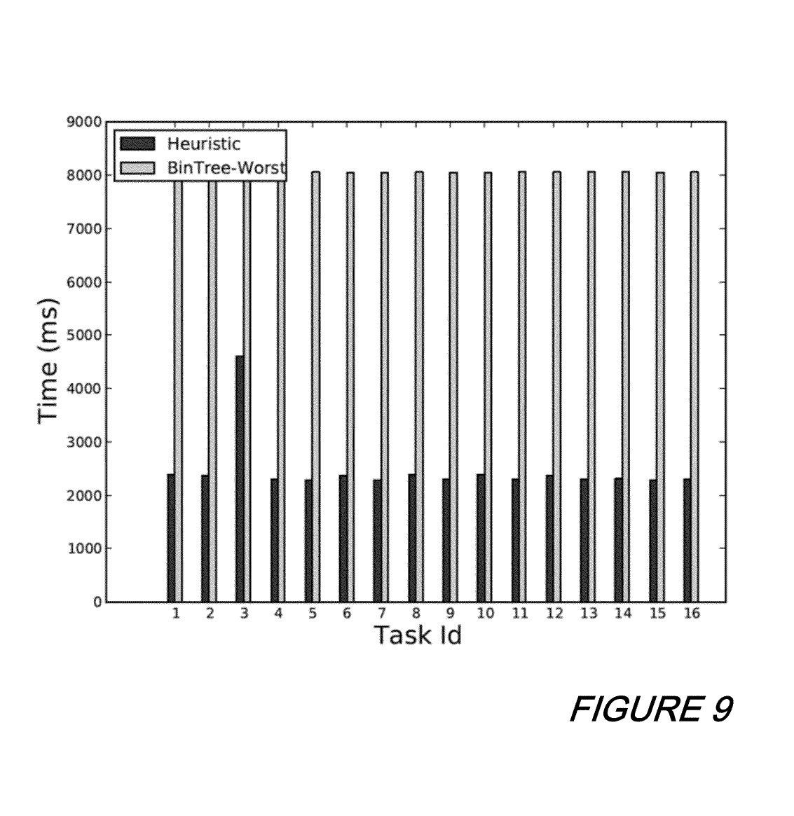

FIG. 8 shows the impact of choking link bandwidth on average model sync times for different weight vector sizes. In this experiment, the in-bandwidth of a randomly selected node is choked to 100 Mbit/sec. Learner tasks, hosted on 20 nodes, are involved in the all-reduce operation. Our experiments demonstrate that the proposed MWD approach outperforms the random binary tree by a significant margin (more than two-fold speedup), for different model sizes. To further understand this result, we plot the model sync times observed by various learners in FIG. 9.

In case of MWD, only the latency of the single choked node is affected. This is because the heuristic places the choked node among the leaves of the spanning tree. On the other hand, a random binary tree, in its worst case, can place the choked learner the interior of the tree thereby choking a significant portion of the pipeline. In this way, MWD achieves significantly better average synchronization times.

### Impact of Varying Link Bandwidth

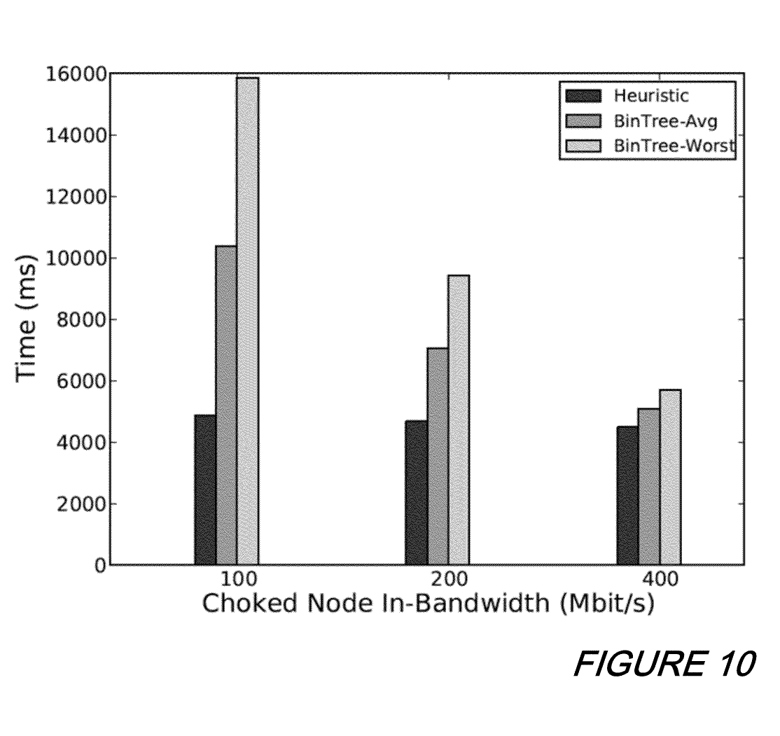

FIG. 10 shows the average model sync times observed for a 32 MB model on 20 learner nodes, with different levels of in-bandwidth choking. It can be seen that as the choking increases, the improvement from our MWD approach increases as well (more than 15% improvement even for 400 Mbit/s). This is due to the fact that MWD successfully localizes the lower bandwidth links to the lower levels of the tree.

### Impact of Complex Link Bandwidth Patterns

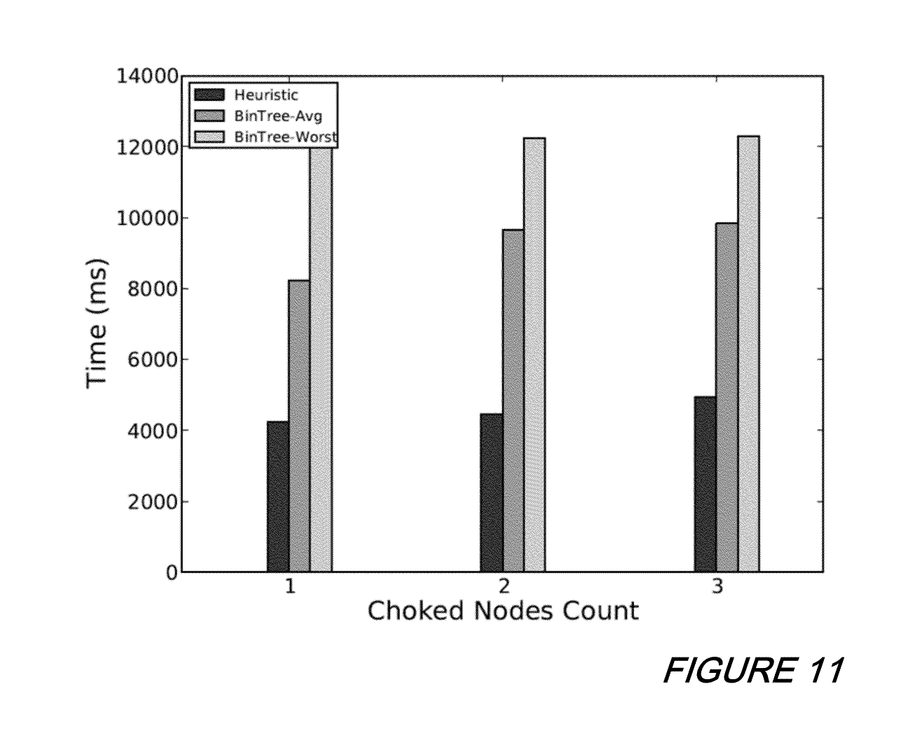

FIG. 11 quantifies the effect of multiple choked links. The links are choked to the same magnitude of 200 Mb/s. The weight vector size in these experiments is 64 MB. Increase in the number of choked links leads to increase in performance benefits of our MWD approach (more than 30%), when compared to the average-case binary tree. This can be explained as follows: as number of choked links increase, there are more chances of a random binary tree placing one of the choked nodes in the interior of the tree and thereby allowing the choked node to impact the overall pipeline throughput. However, note that the performance of the worst case binary tree, where all choked nodes are placed in the interior of the tree, does not vary substantially. This is because, our implementation divides the model into small parts and sends the parts as separate messages in a pipeline. Furthermore, the rate of the pipeline depends entirely on the slowest link, irrespective of the number of such slow links.

However, if the model-size is small, the all-reduce implementation transmits the model as a single message, without any pipelining. In such cases, a random binary tree could place the choked nodes in different levels of the tree, leading to an accumulation of delays. In contrast, MWD places all the choked-nodes among the tree-leaves, ensuring that delays due to choked nodes are overlapped.

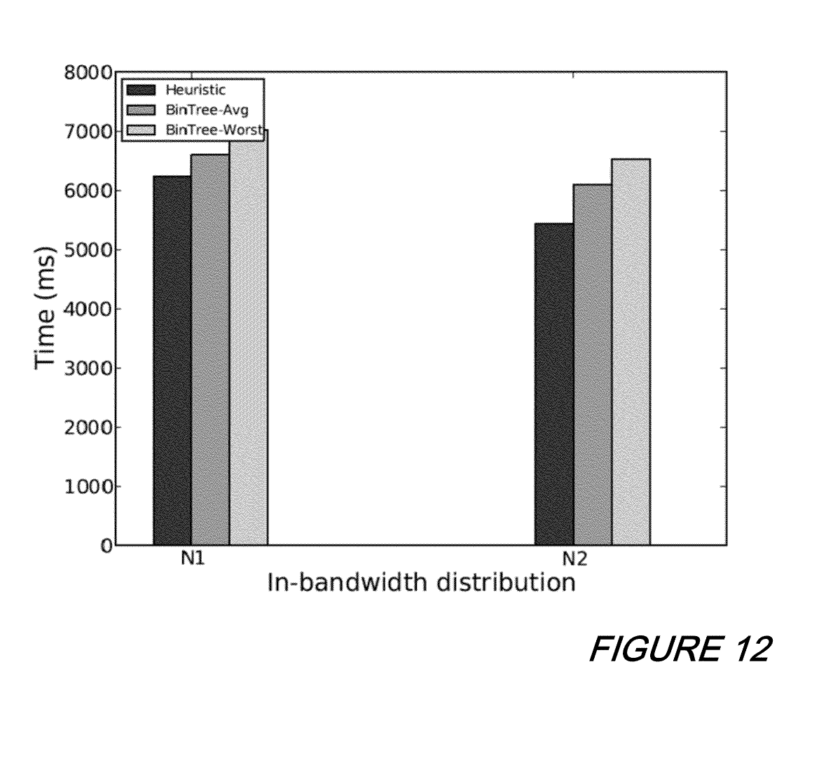

FIG. 12 quantifies the average model sync time when nodes' in-bandwidths are sampled from two normal distributions: (i) mean is 500 Mb/s and standard deviation is 200 Mb/s; and (ii) mean is 700 Mb/s and standard deviation is 300 Mb/s. As evident from our results, when the standard deviation is high, link-bandwidths are dispersed, leading to increased scope for improving the topology. The difference in average sync time is more than 13% between the best and worst overlays for the case of large standard deviation.

As we have learned, using a large number of buckets leads to a fine-grained tracking of key-space activity. However, it also increases overhead of any metrics collection. Thus, we may advantageously extend our methods according to the present disclosure with methods for dynamic merging of contiguous buckets when they exhibit similar activity, and methods for splitting buckets when finer-grained tracking is needed.

While our experimental evaluation of methods according to the present disclosure do not support dynamic physical resource scaling through node additions, the two phase nature of our route-map update protocol provides clear interfaces for such extensions. In particular, the route-installation phase (first-phase) can be used to establish connections with new nodes. Due to the strict ordering between phases, hot-swapping of route-maps in second-phase is advantageously guaranteed to maintain correct operation semantics.

As noted, dynamic compute and network overheads can significantly impact the performance of streaming systems. Accordingly we have disclosed efficient techniques for dynamic topology re-optimization, through the use of a feedback-driven control loop that substantially solve a number of these performance-impacting problems. More particularly, we have disclosed a novel technique for network-aware tuple routing using consistent hashing that improves stream flow throughput in the presence of a number of run-time overheads. We also disclose methods for dynamic optimization of overlay topologies for group communication operations. To enable fast topology re-optimization with least system disruption, we present a lightweight, fault-tolerant protocol. All of the disclosed techniques were implemented in a real system and comprehensively validated on three real applications. We have demonstrated significant improvement in performance (20% to 200%), while overcoming various compute and network bottlenecks. We have shown that our performance improvements are robust to dynamic changes, as well as complex congestion patterns. Given the importance of stream processing systems and the ubiquity of dynamic network state in cloud environments, our results represent a significant and practical solution to these known problems and deficiencies in the art.

At this point, while we have presented this disclosure using some specific examples, those skilled in the art will recognize that our teachings are not so limited. Accordingly, this disclosure should be only limited by the scope of the claims attached hereto.

1. A stream processing acceleration method employing network-aware routing, said method comprising the computer implemented steps of: representing topology link structures using route-maps wherein said route-maps include tuple-routing information and topology structure encoded therein; applying, on-the-fly, the route maps into multiple operators using a topology route-map update method.

2. A method for accelerating stream processing in a network system through the effect of dynamic network-aware topology re-optimization, the method comprising the computer implemented steps of:
choosing, for every operator, a destination operator for outgoing tuples based on route maps wherein said route maps include information on the type and proportion of traffic for each destination operator;
collecting, by a per-topology controller, a number of metrics pertaining to the network system;
determining any bottlenecks in the network system;
based on the determined bottlenecks, generating—by the controller—new route maps that minimize the maximum network and CPU utilization;
installing the new route maps in a consistent manner on a running cluster in the network system using a light-weight atomic route-update protocol.

3. The method according to claim 2 wherein the new route maps that minimize the maximum network and CPU utilization are generated according to the following relationship:
$$minimize {w}_{cu} * \overbrace{{max}_{n} S ( n ) \text{/} C ( n )}^{CU} + {w}_{nu} * \underbrace{{max}_{u , n} F ( u , v ) \text{/} R ( u , v )}_{NU} \\ subject to {x}_{b , n} ∈ \{ 0 , 1 \} ∀ b , n ; {Σ}_{n} {x}_{b , n} = 1 ∀ b \qquad ( 1 )$$
wherein N denotes a set of nodes in the network, n is an individual node in the set N, C(n) denotes the computing capacity (mips) of the node, x_{b,n} is a decision variable indicative of a bucket assigned to the node, b identifies the bucket assigned to an operator-replica on node n, S(n) is he sum of compute-rates of all buckets assigned to n, F(u,v) is the rate of data flowing from nodes u to v and R(u,v) is the actual bandwidth between the two nodes.

4. The method according to claim 3 further comprising the step of modelling traffic as data is received by fine-grained key-space buckets instead of coarse-grained operators such that fine-grained mapping of buckets to nodes is effected.

5. The method according to claim 4 further comprising the step of balancing utilization of all network links.

6. The method according to claim 5 further comprising the step of determining bandwidth estimates from a rate of tuple-acks emitted by different nodes in the network.

7. The method according to claim 6 wherein said bandwidth estimate determination is invoked only when hysteresis-applied system throughput rate in a recent time window drops by a threshold percentage as compared to a long term average wherein the system throughput rate is the rate of tuple-ingestion by a spout and the threshold percentage is 10%.

8. A method for accelerating stream processing in a network system through the effect of an atomic method for modifying topology route maps wherein each topology includes a controller and a spout, each having corresponding kafka queues which form their message sources, the method comprising the computer implemented steps of:
storing, by the controller, new route-maps in its local state and then sending a new route map message, tagged by a version-id, to the spout by placing it in the spout's kafka queue;
reading by the spout, the new route-maps message from its kafka queue, and then appending an install-routes command to the message and sending that appended message to all involved operators by piggybacking on a next start-batch tuple;
receiving, by the spout, acknowledgements from all involved operators and in response sending a routes-installed confirmation message to the controller by placing it in the controller's kafka queue;
storing, by the controller upon receipt of the routes-installed message, the new topology route maps in its local state and then sending an activate new routes message to the spout by placing it in the spout's kafka queue;
upon receiving the activate new routes message, appending, by the spout, the received message onto a next start batch tuple;
sending, by the controller, the piggybacked start-batch tuple after waiting for a successful commit of all currently executing batches;
upon receiving all acknowledgements for the start batch tuple containing activate new routes message, sending by the spout an activated new routes message to the controller by placing it in the controller's kafka queue; and
marking, by the controller, a successful completion.
